(19) United States
(12) Patent Application Publication
(10) Pub. No.: US 2017/0076343 A1
(43) Pub. Date: Mar. 16, 2017

(54) GIFT BOX COLLECTION FORMED OF GIFT-SHAPED CONTAINERS

(71) Applicant: JAKKS Pacific, Inc., Santa Monica, CA (US)

(72) Inventors: Michael Bernstein, Manhattan Beach, CA (US); Gregory Frank, Los Angeles, CA (US); Danny Pestonj, Chatsworth, CA (US)

(21) Appl. No.: 15/265,695

(22) Filed: Sep. 14, 2016

Related U.S. Application Data
(60) Provisional application No. 62/218,393, filed on Sep. 14, 2015.
(60) Provisional application No. 62/275,198, filed on Jan. 5, 2016.

(51) Int. Cl. G06Q 30/06; B65D 6/18; B65D 85/00; A63H 3/52; A47F 5/11; A47F 7/28; A63H 3/00; B65D 51/24; A47F 5/00

(52) U.S. Cl. CPC G06Q 30/0601; B65D 51/245; B65D 7/26; B65D 11/1846; B65D 85/70; A47F 5/0025; A47F 5/11; A47F 7/28; A63H 3/00; A63H 3/52; A47F 2007/0092

(57) ABSTRACT

The present invention relates to gift boxes and, more particularly, to a collection of gift-shaped containers that can be provided in a display. Each of the gift-shaped containers contain a different and unknown toy therein.

### CROSS-REFERENCE TO RELATED APPLICATIONS

This is a non-provisional application of U.S. Provisional Application No. 62/218,393, filed Sep. 14, 2015, the entirety of which is incorporated herein by reference.

This is ALSO a non-provisional application of U.S. Provisional Application No. 62/275,198, filed Jan. 5, 2016, the entirety of which is incorporated herein by reference.

### BACKGROUND OF THE INVENTION

(1) Field of Invention

The present invention relates to gift boxes and, more particularly, to a collection of gift-shaped containers, where the gift-shaped containers each contain a different and unknown toy therein.

(2) Description of Related Art

Collectible toys have long been known in the art and are often collected based on their distinct features. For example, a collector typically seeks out a particular collectible that they do not currently have to add to their collection. Thus, the selection is based on a known item. Further, containers come in a variety of shapes and forms; however, nothing heretofore devised has provided a collection of gift-shaped containers, where the gift-shaped containers each contain a different and unknown toy therein.

Thus, a continuing need exists for a collection of gift-shaped containers, where the gift-shaped containers each contain an unknown toy therein.

### SUMMARY OF INVENTION

The present invention is directed to a collection of gift-shaped containers forming a gift box collection. The gift box collection includes a display having a plurality of the gift-box shaped containers. Notably, the gift-shaped containers each contain a different and unknown toy therein.

In another aspect, each of the gift-shaped containers includes a plurality of hinged panels that open to reveal the unknown toy therein and serve as a backdrop for the unknown toy. The inside walls of each panel are themed to match the toy.

In another aspect, the plurality of hinged panels comprises a bottom panel; a rear panel hingedely connected with the bottom panel; a right side panel hingedely connected with the rear panel; a left side panel hingedely connected with the rear panel; and a front panel hingedely connected with the bottom panel.

In yet another aspect, a character peg protrudes from the bottom panel to connect with the unknown toy.

In another aspect, this disclosure includes a method of providing a surprise to a consumer. The method includes steps of displaying multiple gift-shaped containers (each of the gift-shaped containers containing a different and unknown toy therein) and selling to the consumer the gift-shaped container. Thus, the consumer purchases one of the many gift-shaped containers without knowledge of the specific content within the gift-shaped container.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a store display having a plurality of gift-shaped containers, with ribbons, therein;

FIG. 2 is an illustration of a gift-shaped container having an unknown toy therein;

FIG. 3 is an illustration of the gift-shaped container, depicting the lid removed to reveal the unknown toy;

FIG. 4 is an illustration of the gift-shaped container, depicting the side panels and front panel of the container being flipped around;

FIG. 5 is an illustration of the gift-shaped container, depicting the side panels and front panel as flipped around to position the character peg on an elevated external surface; and

FIG. 6 is an illustration of the gift-shaped container, depicting the unknown toy as standing atop the box and connected with the character peg.

### DETAILED DESCRIPTION

The present invention relates to gift boxes and, more particularly, to a collection of gift-shaped containers, where the gift-shaped containers each contain an unknown toy therein. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

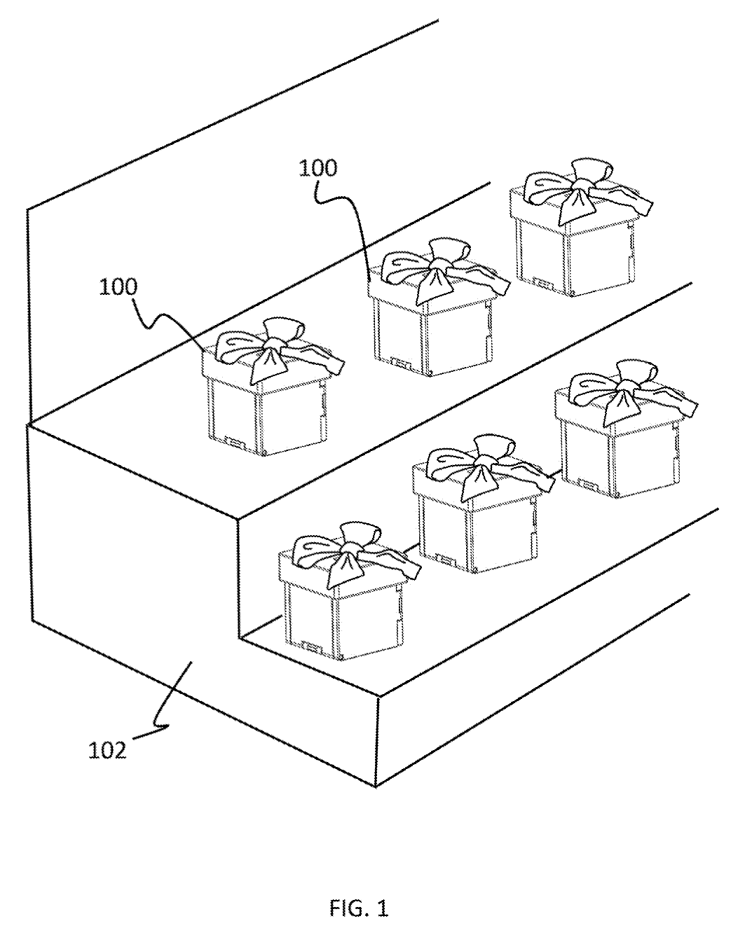

As noted above and as shown in FIG. 1, this disclosure describes a collection of gift-shaped containers 100, where the gift-shaped containers 100 each contain a different and unknown toy therein. As shown in the example retail display 102, the collection includes multiple (i.e., plurality) gift-shaped containers 100. The gift-shaped containers 100 can be formed in any desired shape, a non-limiting example of which includes the box-shape as shown, or in other aspects, shaped to resemble a gift bag, or an elongated box, or any other desired shape.

The retail display 102 is any suitable display that can be provided to hold and exhibit a plurality of the containers 100, a non-limiting example of which includes a multi-tiered cardboard display. Importantly, the gift-shaped containers 100 each contain different and unknown toy therein. It should be understood that although a single retail display 102 may contain multiple containers 100 that each contain the same toy, a micro-collection within the display 102 (i.e., a subset of those in the retail display 102), each contain a distinct unknown toy. The unknown toy is any suitable toy that can be positioned within such a container 100, non-limiting examples of which include cars, plastic animals, plastic figurines, etc. Thus, when presented to a child (or consumer) at the retail display 102 point, the contents of each gift-shaped container 100 are entirely unknown to the consumer. For example, the content of a particular box (i.e., gift-shaped container) could be a toy dog, toy cat, toy turtle, etc.

The present invention is also directed to a method of providing a surprise gift to a consumer. The method including steps of: (a) displaying, at a retail display 102, multiple gift-shaped containers 100, where each of the gift-shaped containers 100 containing a different and unknown toy (e.g., plastic animal, etc.) therein, and (b) selling to the consumer one or more of the gift-shaped containers 100 such that the consumer purchases one of the many containers 100 without knowledge of the specific content within the container 100.

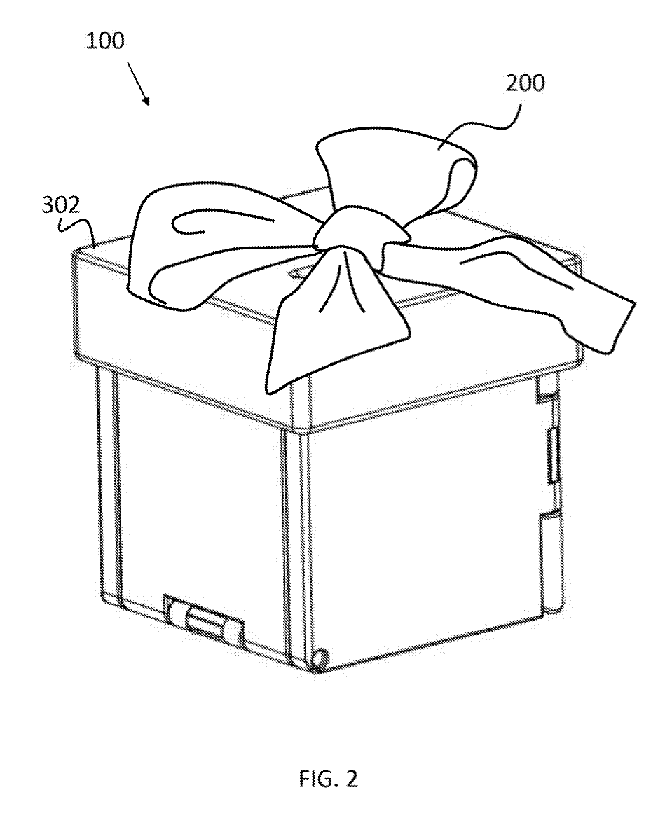

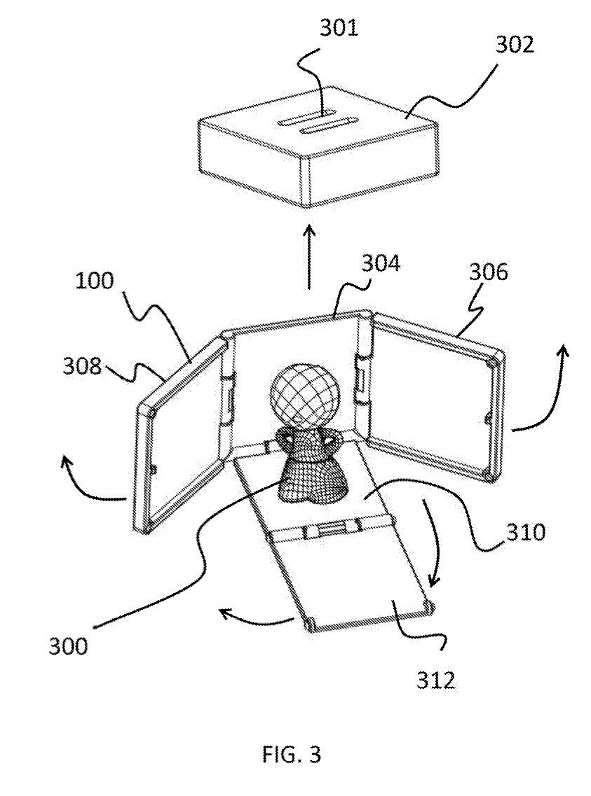

As can be appreciated, the gift-shaped container 100 provides excitement to the consumer as it appears as a real present, while the contents within the container 100 or box are always a surprise only to be determined by purchasing and opening the gift-shaped container 100. As shown in FIG. 2, the gift-shaped container 100 can be designed to appear as an actual wrapped present. For example, the container 100 can be formed to include a bow 200 (e.g., real fabric bow or molded bow) adhered to a lid 302 that adds to the realism and excitement to the consumer or child purchasing such a container 100. The bow 200 can be adhered to a lid 302 using any suitable mechanism, technique, or device. As a non-limiting example and as shown in FIG. 3, the lid 302 can be formed to include a pair of bow slots 301 through which the bow can be threaded and then tied. In other aspects, the bow can simply be pre-formed and glued to the lid 302, or otherwise affixed in any suitable manner.

In various embodiments and as depicted in FIGS. 3 through 6, the gift-shaped container 100 itself can be formed to have hinged panels (e.g., formed of plastic, metal, paperboard, etc.) that open up to reveal the toy 300 therein and serve as a backdrop for the toy 300. For example and as shown in FIG. 3, once the lid 302 is removed, the container 100 is left with a back panel 304, a right side panel 306, a left side panel 308, a bottom panel 310, and a front panel 312. In various embodiments, the panels are hingedly connected with one another and collectively form a box-shaped container that conceals the toy 300.

Further, the inside walls of each panel can be themed (e.g., with stickers or paint, or molded patterns, etc.) to match the toy 300. For example, the inside walls of each panel can be themed with iconic images of a city or country and the toy 300 (e.g., doll or figure) inside will wear clothing or attire to match the location as depicted on the wall panels. For example, the gift-shaped container 100 can be opened to reveal a toy 300 (e.g., doll) and a country's flag (e.g., via a sticker adhered to an inside surface of a panel) that is associated with the clothing that is worn by the doll. In various embodiments, each doll is dressed in their native local fashions and features mix and match play clothing so that children can mix and match fashions from around the world, to create their own unique styles!

Thus, in operation, a user can swing out the panels which reveals the toy 300 and also reveals the inside walls of the panels. In one non-limiting example and as depicted in FIG. 3, the lid 302 can be removed, which allows the user to convert the container into the backdrop. For example, the right and left side panels 306 and 308 are hingedly connected with the back panel 304, while the front panel 312 is hingedly connected with the bottom panel 310. In this aspect, the side panels 306 and 308 can be pivoted away from the bottom panel 310 while the front panel 312 pivots down and away from the side panels 306 and 308, resulting in the backdrop as shown in FIG. 3.

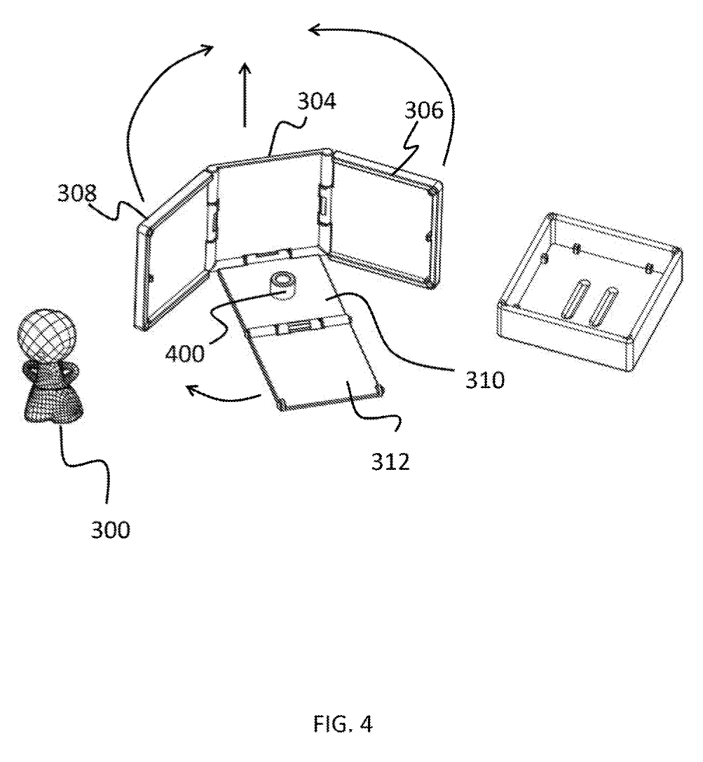

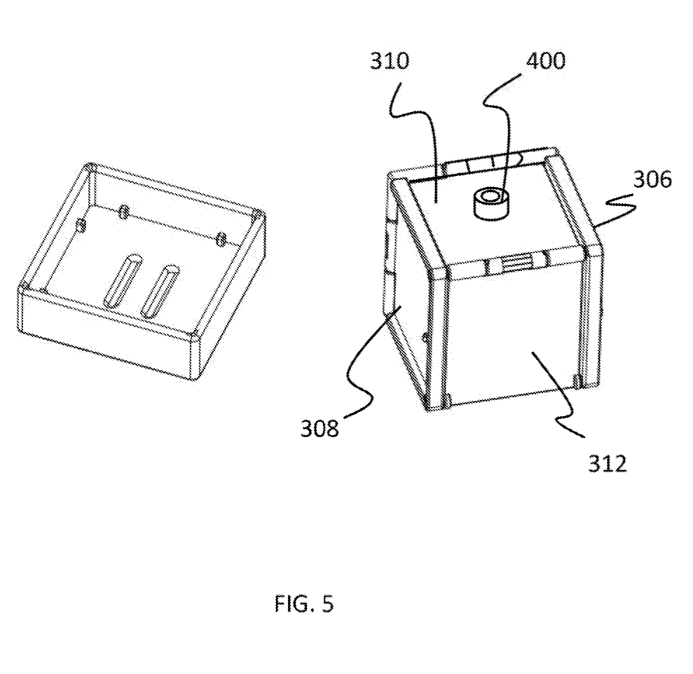

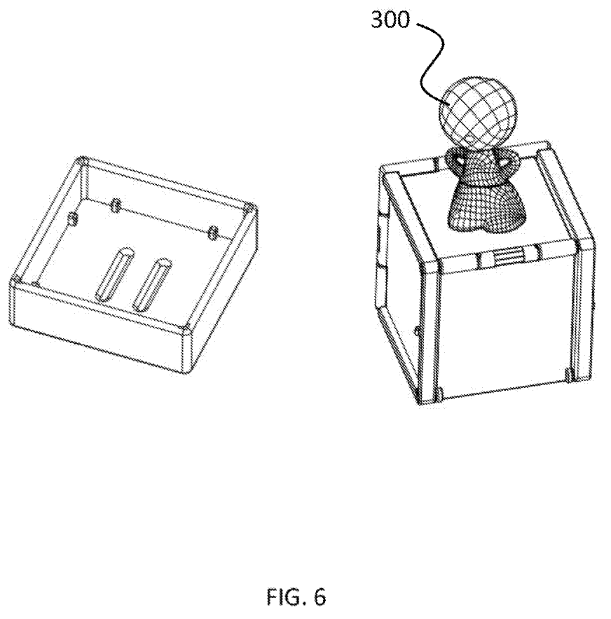

In various embodiments and as shown in FIG. 4, the toy 100 can be affixed with the bottom panel 310 via a character peg 400 that protrudes from the bottom panel 310 (e.g., is made of plastic and molded with the bottom panel 310). Thus, when the toy 300 is removed from the bottom panel 310 the character peg 400 is exposed. It should be noted that the character peg 400 is included in some embodiments, while various other embodiments can be formed without such a peg. In additional various embodiments, the right and left side panels 306 and 308 can be further rotated, with the front panel 312 then pivoted further down to elevate the bottom panel 310. As shown in FIG. 5, when the panels are rotated around and the bottom panel 310 is elevated, the side panels 306 and 308, rear panel 304, and front panel 312 are all reversed. Further, a pedestal is then formed in which the bottom panel 310 is now elevated with the character peg 400 protruding therefrom. As shown in FIG. 6, the toy 300 (which includes a recess that matingly engages with the character peg 400) can then be easily connected with the character peg 400 to display the toy 300.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may, in various embodiments, occur in any desired order and fall within the scope of the present invention.

What is claimed is:

1. A gift box collection, comprising:
a display having a plurality of gift-box shaped containers, the gift-shaped containers each containing a different and unknown toy therein.

2. The gift box collection as set forth in claim 1, wherein each gift-shaped container includes a plurality of hinged panels that open to reveal the unknown toy therein and serve as a backdrop for the unknown toy.

3. The gift box collection as set forth in claim 2, wherein the inside walls of each panel are themed to match the toy.

4. The gift box collection as set forth in claim 3, wherein the plurality of hinged panels comprises:
a bottom panel;
a rear panel hingedely connected with the bottom panel;
a right side panel hingedely connected with the rear panel;
a left side panel hingedely connected with the rear panel; and
a front panel hingedely connected with the bottom panel.

5. The gift box collection as set forth in claim 4, wherein a character peg protrudes from the bottom panel to connect with the unknown toy.

6. A method of providing a surprise to a consumer, comprising steps of:
displaying multiple gift-shaped containers, each of the gift-shaped containers containing a different and unknown toy therein; and
selling to the consumer a gift-shaped container such that the consumer purchases one of the multiple gift-shaped containers without knowledge of the specific content within the gift-shaped container.

7. A gift-shaped container, comprising:
a plurality of panels hingedly connected with one another, such that the plurality of panels fold together to form a container;
a lid for connecting with the container, the lid having a bow adhered thereto, such that when the lid is connected with the container, the lid and container collectively form a gift-shaped container; and
an unknown toy positioned within the container.

8. The gift-shaped container as set forth in claim 7, wherein the plurality of panels comprises:
a bottom panel;
a rear panel hingedely connected with the bottom panel;
a right side panel hingedely connected with the rear panel;
a left side panel hingedely connected with the rear panel; and
a front panel hingedely connected with the bottom panel.

9. The gift-shaped container as set forth in claim 8, wherein a character peg protrudes from the bottom panel to connect with the unknown toy.
